(19) United States
(12) Patent Application Publication
(10) Pub. No.: US 2005/0017466 A1
(43) Pub. Date: Jan. 27, 2005

(54) Grocery cart step stool

(76) Inventors: Cheryl Dolin, Concord, NH (US); Russell Aubertin, Concord, NH (US); Nathan Ezra Dolin-Aubertin, Concord, NH (US)

Correspondence Address: Cheryl Dolin, 465 Clinton Street, Concord, NH, 03301, US

(21) Appl. No.: 10/837,770

(22) Filed: May 3, 2004

Related U.S. Application Data
(60) Provisional application No. 60/467,351, filed on May 2, 2003.

(51) Int. Cl. B62D 39/00

(52) U.S. Cl. 280/33.992

(57) ABSTRACT

An improvement in the form of an attachment to a conventional shopping cart comprises a portable step, which is temporarily affixed to the cart in a position to be connected to the front or back of the shopping cart. The portable stair is secured to the top frame in the form of metal hooks. The attachment when fixed is off the ground allowing complete mobility of the cart. The stair becomes engaged when the weight of the user compresses the springs by stepping on the stair, thus securing the stair to the floor. When one stands upon the step, it allows one to reach articles on higher shelves. When compressed against the floor surface, it provides a stable step for the user. The rubber feet also provide a brake that will prevent movement of the cart while on is using the step attachment.

### RELATED APPLICATIONS

This application claims priority to U.S. Provisional Application No. 60/467,351, titled Grocery Cart Step Stool, and filed on May 2, 2003.

### BACKGROUND OF THE INVENTION

1. Field of the Invention

The invention relates generally to shopping carts and in particular to attachments therefore. In yet a more particular sense, the invention comprises devices that are attachable to conventional shopping carts without requirements of making any changes in the shopping carts, thus permitting the attachment to be secured to a shopping cart that is already in use. The attachment falls in the category of those that are removable in respect to the shopping cart between retracted, non-use positions, and use positions in which the attachments project outwardly from the shopping cart, to present in an elevated platform on which one may stand to reach articles on higher shelves of the supermarket or other establishment in which the shopping cart is being used.

2. Description of the Related Art

It has been proposed to provide attachments to wheeled carts or similar vehicles. Such attachments have been provided for various purposes, and in some instances, attachments have been provided for the purpose of affording a platform on which one may stand to reach areas that are too high for a person of average or below average height standing on the floor. In the prior art devices, however, there has been no suggestion for an attachment which can be made separately and distinctly from a grocery shopping cart of modern day design, with the attachment being so designed to be swiftly and easily attachable to or detachable from a shopping cart, without requirement of the expenditure of an excessive amount of time or labor.

Further, in the prior art, it has not been previously suggested, so far as is known, that the shopping cart attachment be so designed as to not interfere in any way with the adaptability of the shopping cart to be nested with other shopping carts when not in use. This is a very important requirement so far as grocery shopping carts are concerned, since any attachment that would interfere with the nesting procedure would be incapable of commercial use to any degree. Shopping carts must be stored in relatively small areas when not in use, and to this end are especially designed to nest almost completely, to occupy a minimum amount of space when a complete, extended line of similar carts are awaiting use in a store adjacent to the entrance.

The present invention has been particularly designed to obviate the difficulties noted with respect to the prior art devices. To this end, the invention is completely removable and can be stored at the entrance of the grocery store and returned to it rack upon exiting the store. The invention is adapted to be swiftly and easily connected or detached from shopping carts of conventional manufacture that are already in use, thus permitting the device to be purchased as a separate item from the company operating the supermarket, and attached to shopping carts that have already been placed in the supermarket.

At the same time, the invention has an important objective of providing of a step attachment of the type described previously herein, which is swiftly operable to a use position, in which it will attach to the front or rear of the cart, project outwardly from the cart so as to be usable by anyone desiring to reach an article on the shelf.

### SUMMARY OF THE INVENTION

The subject matter of this application involves, in some cases, interrelated products, alternative solutions to a particular problem, and/or a plurality of different uses of a single system or article.

The present invention comprises an attachment, which is capable of manufacture separately from a shopping cart to which it is to be eventually connected. The attachment is so designed as to be connectable to a shopping cart of completely conventional manufacture, without detracting in any way from the capability of the shopping cart to be nested or telescoped with other, identical carts when not in actual use. To this end, the invention comprises 2-steps which are attached to metal hooks for attaching to the grocery cart.

Steel tubes may be used to support the steps and extend from the underneath. Metal springs can be attached to the rear of the bottom step so when weight is applied to the step they compress allowing feet to contact floor.

Steel tubes with attached rubber feet may be attached to the front of the bottom step. These may help by acting as brakes when the spring feet are engaged.

Two metal rods run through the steps at the rear and have hooked ends, which are swiftly attached over the front or the rear of the cart.

When no weight is put upon the steps, the stairs are in their unused position and do not interfere with the mobility of the cart.

The entire device is so designed so as to be completely removable thus presenting no interference with conventional nesting or telescoping of the shopping cart into a similar shopping cart. The device is completely removable upon entering and exiting a store.

Other advantages, novel features, and objects of the invention will become apparent from the following detailed description of non-limiting embodiments of the invention when considered in conjunction with the accompanying drawings, which are schematic and which are not intended to be drawn to scale. In the figures, each identical or nearly identical component that is illustrated in various figures typically is represented by a single numeral. For purposes of clarity, not every component is labeled in every figure, nor is every component of each embodiment of the invention shown where illustration is not necessary to allow those of ordinary skill in the art to understand the invention. In cases where the present specification and a document incorporated by reference include conflicting disclosure, the present specification shall control.

### BRIEF DESCRIPTION OF THE DRAWINGS

While the invention is particularly pointed out and distinctly claimed in the concluding portions herein, a preferred embodiment is set forth in the following detailed description which may be best understood when read in connection with the accompany drawings, in which:

FIG. 1 is a side elevational view of a shopping cart of conventional design, to which is attached a step attachment constructed according to the present invention, the step attachment being shown in full lines in a use position.

FIG. 2. is a front elevation of a shopping cart of conventional design, to which is attached a step attachment constructed according to the present invention, the step attachment being shown in full lines in a use position. The rubber feet are shown touching the floor.

FIG. 3. is a photograph demonstrating bottom attachment to the front of the grocery. The curved metal feet rest upon the front rail of the cart.

FIG. 4. is a photograph demonstrating the hooked metal rods attaching to the top rail of the grocery cart of conventional design.

FIG. 5 is a photograph demonstrating the entire grocery cart step stool attachment attached to the front of the grocery cart of conventional design. The photograph shows the hooked rods attached to the front of the cart. The springs are holding the stool in the up position allowing for the cart to be pushed through the store.

### DETAILED DESCRIPTION OF THE INVENTION

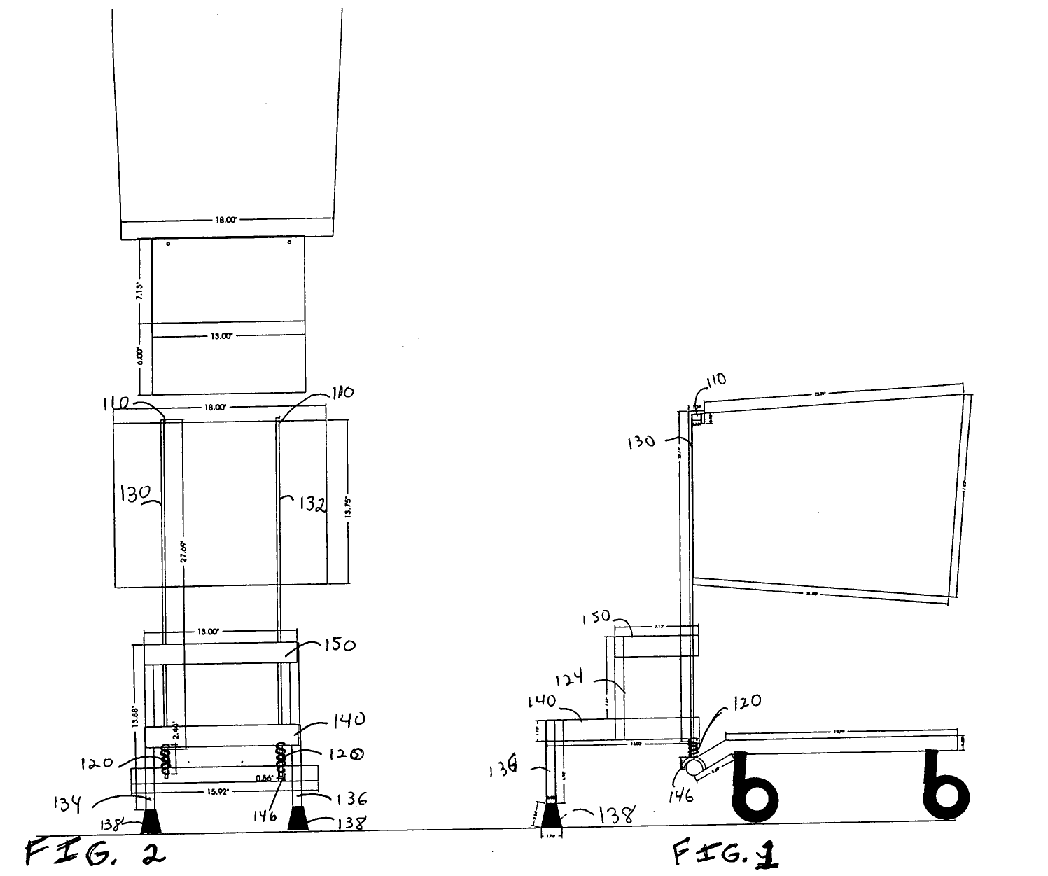

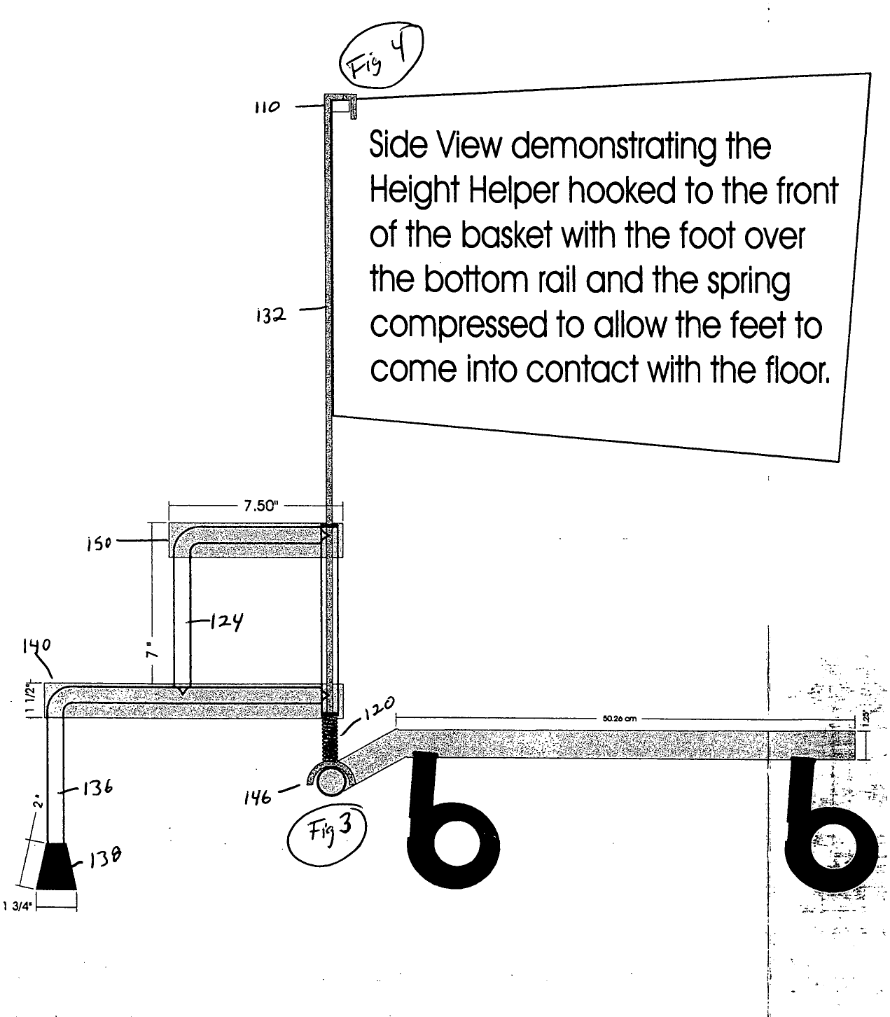

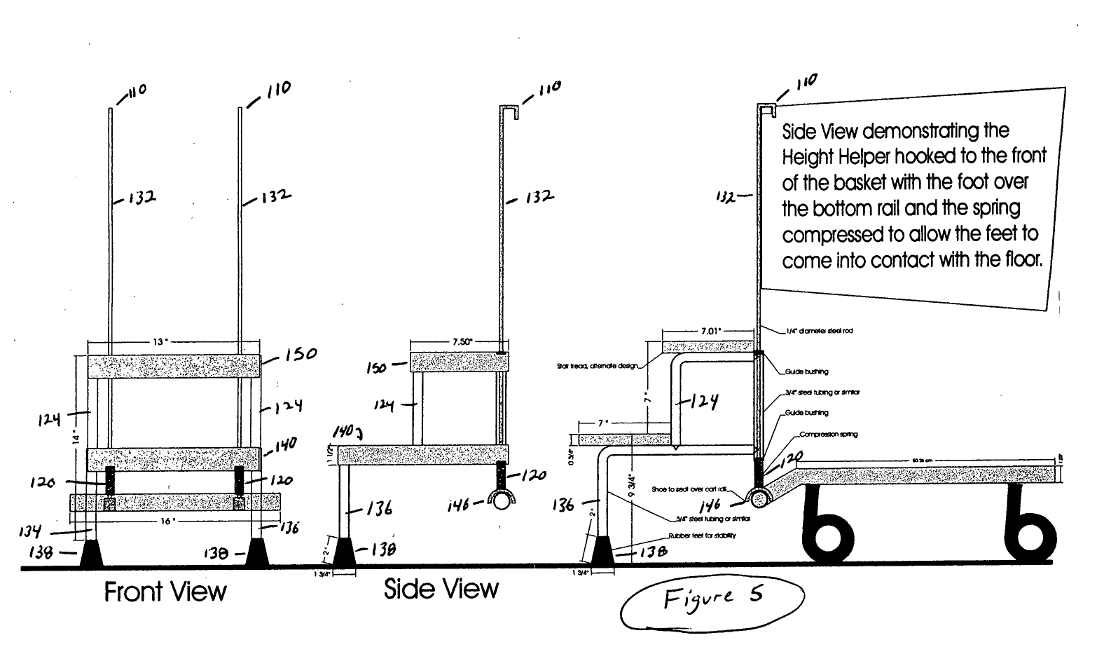

In one aspect, a device is provided that can attach to a common grocery cart and provide a movable step stool for a shopper. As shown in FIGS. 1-5, in one embodiment the step stool can be removably attached to the front of a grocery cart. Connectors, such as hooks 110 can be attached to the rail of the grocery cart and can securely hold the step stool to the cart while the cart is in motion. The step stool, in some cases, does not reduce the volume of the cart. Springs 120 surround rods 130 and 132, which pass through sleeves 122 and 124. Sleeves 122 and 124 also connect treads 140 and 150 and help provide rigidity to the step stool. The springs keep legs 134 and 136, as well as the treads 140 and 150 off of the floor when the cart is in motion, or when no one is using the step stool. When a user steps on the step stool, the springs may be compressed and the legs 134 and 136 become in contact with the floor. The legs of the step stool can support the weight of the user. Support braces 142 and 144 connect treads 140 and 150 and provided rigidity to the step stool. Curved metal feet 146 and 148 are shaped to rest on a lower cross bar of a standard grocery cart. The curved metal feet 146 and 148 are attached to rods 130 and 132. The cart is not upset by the user because the user's weight is supported by the step stool, which also serves to brake and anchor the grocery cart when the step stool is in use. Thus, not only can the user gain height by stepping on treads 140 and 150, but the grocery cart is also secured while the step stool is in use. Rubber feet 138 on the bottom of legs 134 and 136 (eg, rubber) can help to secure the entire cart, even if accidentally bumped by another shopper. When the shopper is done, the step stool can be removed simply by lifting it off of the cart. In this manner, grocery carts can be stored in their usual manner and step stools can be installed and used by those who benefit from them.

The step stool may be made of metal such as steel or aluminum or plastic, such as PVC, polycarbonate, polyurethane, polyethylene, or polypropylene. Parts can be secured with screws, bolts, welds, adhesive or other methods know to those skilled in the art. Structural pieces such as hooks 110, rods 130 and 132, legs 134 and 136, and tread 160 are preferably made of materials that can support a heavy shopper. Materials are also preferably weatherproof as the step stool may be left in the weather on occasion. Polymeric materials may be preferred in these instances.

In alternative embodiments, the step stool can be configured to attach to the end of the cart closest to the user. In these cases, it is preferred that the step or steps are configured to be collapsible or slidable or in some other way, able to be compressed so as to not interfere with the movement of the user trying to push the cart. For instance, the steps might fold upward, significantly decreasing the amount of horizontal space taken up by the step stool while the cart is being pushed. Of course, if the cart itself can be re-designed, then the step stool could fold right into the cart but this expense may not be preferred. A compressible or foldable design may also be used on the front of the cart to reduce the overall length of the cart/height holder combination. Such a design choice may also facilitate storage. Foldable designs such as those used in the step stool industry may be used when space minimization is desired.

Springs lifting the step stool off the ground during movement of the grocery cart can be placed in other positions, such as on the upper rods rather than on the lower support. Springs may be replaced by elastomers and other materials providing enough force to lift the step stool off the ground but not so great as to resist the weight of the lightest foreseen shopper. Hydraulic or pneumatic pistons may also be employed.

Alternatively, instead of being lifted off the ground, the step stool may use wheels or casters in order to be pushed along the floor as is the cart to which the step stool is attached. These embodiments may not be as horizontally stable as the liftable version described herein, but a brake, for instance, one similar to those used on wheelchairs, could be employed to stabilize the device and grocery cart. Any other device that prevents rolling could also be attached to the step stool or cart in order to prevent horizontal movement when someone is standing on the device.

This example is for illustrative purposes and should not be used to limit the scope of the invention in any way. Given this disclosure, multiple uses and embodiments will be readily apparent to those skilled in the art.

1. A step stool comprising:
at least one surface for standing;
a connector constructed and arranged for attaching the standing surface to a grocery cart; and
a spring configured to lift the step stool off the ground when the attached grocery cart is in motion.

2. The step stool of claim 1 wherein the step stool mounts on a forward end of the grocery cart, opposed to a handle used to push the grocery cart.

3. The step stool of claim 1 wherein the spring is configured to allow the step stool to contact the floor when a human user steps on the step stool.

4. The step stool of claim 1 wherein the step stool is removably attached to the grocery cart.

5. The step stool of claim one wherein the step stool can be attached to and removed from the grocery cart without tools.

6. A method of reaching a high shelf comprising:
moving a grocery cart to a position proximate the high shelf;
stepping on a step stool attached to the grocery cart to increase a user's effective height and to lower the step stool so that it comes into contact with the floor; and
reaching an item on the high shelf.

7. The method of claim 2 for comprising moving the grocery cart and step stool together as a unit through a grocery store.
